(19) United States
(12) Patent Application Publication
(10) Pub. No.: US 2023/0252088 A1
(43) Pub. Date: Aug. 10, 2023

(54) SYSTEMS AND METHODS FOR SECURE DOCUMENT MANAGEMENT

(71) Applicant: EscrowTab, Inc., Tempe, AZ (US)

(72) Inventors: Kolin Blain Porter, Tempe, AZ (US); Logan Turley, Scottsdale, AZ (US)

(73) Assignee: EscrowTab, Inc., Tempe, AZ (US)

(21) Appl. No.: 17/666,477

(22) Filed: Feb. 7, 2022

(51) Int. Cl. G06F 16/93; G06F 16/901; H04L 9/32

(52) U.S. Cl. CPC G06F 16/93; G06F 16/9014; H04L 9/3236; H04L 2209/38

(57) ABSTRACT

A system for secure document management can include a document execution sub-system configured to receive a document, extract data from the document, and facilitate electronic execution of the document; a secure storage sub-system configured to securely store the data extracted from the document; a registration sub-system configured to store the data extracted from the document, facilitate secured access to the data extracted from the document, record an electronically executed version of the document with an external governmental recordation entity, create a hash from the data extracted from the document, create a non-fungible token comprising the hash and a reference to the electronically executed version of the document, and store the hash on a blockchain.

### CROSS REFERENCE TO RELATED APPLICATIONS

This application is related to U.S. Pat. App. No. 17/467,152 filed on Sep. 3, 2021 and entitled “Systems and Methods for Electronic Document Execution”, which is a continuation-in-part of U.S. Pat. App. No. 17/105,185 filed on Nov. 25, 2020 and entitled “EscrowTab Mobile App. System and Method”, which is a continuation of U.S. Pat. App. No. 16/896,458 filed on Jun. 9, 2020, which issued as U.S Pat. No. 10,885,580 on Jan. 5, 2021 and which is a continuation of U.S. Pat. App. No. 15/732,807 filed on Jan. 3, 2018, which issued as U.S Pat. No. 10,713,714 on Jul. 14, 2020 and which is a non-provisional of U.S. Pat. App. No. 62/498,865 filed on Jan. 10, 2017. Each of these documents are incorporated herein by specific reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

Field of the Invention. The present disclosure relates generally to management of documents and more specifically relates to the secure processing, recording, and tracking of documents, such as such as deeds, notes, and other documents.

### Description of the Related Art

Currently, real estate documents, as other types of documents, are typically processed, executed, and recorded in paper form. This can be labor intensive, inconsistent, error prone, and insecure. Efficiency, consistency, reliability, and security can be gained using the features and/or processes disclosed herein.

### BRIEF SUMMARY OF THE INVENTION

Applicants have created new and useful devices, systems and methods for secure management of documents, such as deeds, notes, and other documents.

In at least one embodiment, a method for secure document management can include receiving the document, and creating an electronic version of the document, such as by digitizing the document, if it is not received in an electronic format; extracting data from the electronic version of the document; executing the document or receiving an executed version of the document; storing the data in a secure storage system; recording the executed version of the document in a governmental recordation system; creating a hash of the document; creating a non-fungible token for the document, the non-fungible token including the hash and a reference to the executed version of the document; and storing the non-fungible token on a blockchain. The document can be a real estate deed, a promissory note, another real estate related document, a contract, or other document.

In at least one embodiment, digitizing the document can include performing an optical character recognition scan of the document. In at least one embodiment, extracting the data from the electronic version of the document can include conforming the data to a java script object notation format. In at least one embodiment, recording the executed version of the document can include electronically transmitting the executed version of the document to the governmental recordation system.

In at least one embodiment, recording the executed version of the document can include electronically transmitting at least a sub-set of the data extracted from the electronic version of the document to the governmental recordation system. In at least one embodiment, recording the executed version of the document can include receiving, from the governmental recordation system, recordation requirements; creating a recordation package in conformance with the recordation requirements, the recordation package including the executed version of the document and at least a sub-set of the data extracted from the electronic version of the document; transmitting the recordation package to the governmental recordation system; receiving, from the governmental recordation system, confirmation of recordation of the executed version of the document; and providing, to a user, notification of recordation of the executed version of the document.

In at least one embodiment, creating the hash of the document can include creating the hash from the electronic version of the document, the executed version of the document, the data extracted from the document, or any combination thereof. For example, the hash can be created from a sub-set of the data extracted from the electronic version of the document. In at least one embodiment, the hash includes a sub-set of the data extracted from the document. Any portion of the hash may be encoded, such that, for example, creating the hash of the document can include encoding at least a sub-set of the data extracted from the document. Thus, for example, the hash can include an encoded representation of at least a subset of the data extracted from the document.

In at least one embodiment, the executed version of the document can also be stored in the secure storage system. In at least one embodiment, the reference to the executed version of the document can include a link to the executed version of the document in the secure storage system. In at least one embodiment, the reference to the executed version of the document can include a link to the executed version of the document in the governmental recordation system.

In at least one embodiment, the data extracted from the electronic version of the document can be registered. In at least one embodiment, registering the data can include confirming the data conforms to a java script object notation format and a mortgage industry standard. In at least one embodiment, the data can be used to populate a record in a searchable database. In at least one embodiment, the record can be populated with the executed version of the document. In at least one embodiment, the reference to the executed version of the document can include a link to the executed version of the document in the record in the searchable database. In at least one embodiment, the searchable database can be distinct and independent from the secure storage system and the governmental recordation system, the secure storage system can be distinct and independent from the searchable database and the governmental recordation system, the governmental recordation system can be distinct and independent from the searchable database and the secure storage system, or any combination thereof.

In at least one embodiment, the secure storage system can include the data extracted from the document. In at least one embodiment, the non-fungible token can include the hash, which can be created from a sub-set of the data extracted from the electronic version of the document. In at least one embodiment, the non-fungible token can include a sub-set of the data extracted from the document.

In at least one embodiment, the hash in the non-fungible token on the blockchain can be updated when the data changes. In at least one embodiment, a new hash can be created when the data changes. The new hash can be added to the non-fungible token on the blockchain and/or be substituted for the previous hash in the non-fungible token on the blockchain. In at least one embodiment, the second, or new, hash can reference the first, or previous, hash.

In at least one embodiment, a system for secure document management can include a document execution sub-system; a secure storage sub-system; and a registration sub-system. In at least one embodiment, the document execution sub-system can be configured to receive a document, extract data from the document, facilitate electronic execution of the document, or any combination thereof. In at least one embodiment, the secure storage sub-system can be configured to securely store the data extracted from the document. In at least one embodiment, the registration sub-system can be configured to store the data extracted from the document, facilitate secured access to the data extracted from the document, record an electronically executed version of the document with an external governmental recordation entity, create a hash from the data extracted from the document, create a non-fungible token comprising the hash and a reference to the electronically executed version of the document, store the hash on a blockchain, or any combination thereof.

In at least one embodiment, the registration sub-system can be configured to allow full access to the data extracted from the document at a first security level, allow read-only access the data extracted from the document at a second access level, allow read-only access to a subset of the data extracted from the document at a third access level, or any combination thereof. In at least one embodiment, the registration sub-system can be configured to update the 1) hash in the non-fungible token on the blockchain, and/or 2) the data in the secure storage sub-system when the data extracted from the document changes. In at least one embodiment, the registration sub-system is further configured to render the document from the data in the secure storage sub-system. In at least one embodiment, the registration sub-system can be configured to validate a user, reject changes from an unvalidated user, accept a modifying document from a validated user, update the data in the secure storage sub-system upon acceptance of the modifying document, record the modifying document with the external governmental recordation entity upon acceptance of the modifying document, update the hash in the non-fungible token on the blockchain upon acceptance of the modifying document, or any combination thereof.

In at least one embodiment, the registration sub-system can be configured to securely store the electronically executed version of the document. In at least one embodiment, the reference to the electronically executed version of the document can include a link to the electronically executed version of the document in the registration sub-system and/or a link to the electronically executed version of the document at the external governmental recordation entity.

In at least one embodiment, the secure storage sub-system can be configured to securely store the electronically executed version of the document. In at least one embodiment, the reference to the electronically executed version of the document can include a link to the electronically executed version of the document in the secure storage sub-system.

### BRIEF DESCRIPTION OF THE SEVERAL VIEWS OF THE DRAWINGS

FIG. 1 is a block diagram of one of many embodiments of a system for secure document management according to the disclosure.

FIG. 2 is a flow chart of one of many embodiments of a method for secure document management according to the disclosure.

FIG. 3 is a flow chart of one of many embodiments of a method for secure document recordation according to the disclosure.

### DETAILED DESCRIPTION OF THE INVENTION

The Figuresdescribed above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer’s ultimate goal for the commercial embodiment. Such implementation-specific decisions may include, and likely are not limited to, compliance with system-related, business-related, government-related and other constraints, which may vary by specific implementation, location and from time to time. While a developer’s efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Process flowcharts discussed herein illustrate the operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Applicants have created new and useful devices, systems and methods for secure management of documents, such as deeds, notes, and other documents.

In at least one embodiment, a method for secure document management can include receiving the document, and creating an electronic version of the document, such as by digitizing the document, if it is not received in an electronic format; extracting data from the electronic version of the document; executing the document or receiving an executed version of the document; storing the data in a secure storage system; recording the executed version of the document in a governmental recordation system; creating a hash of the document; creating a non-fungible token for the document, the non-fungible token including the hash and a reference to the executed version of the document; and storing the non-fungible token on a blockchain. The document can be a real estate deed, a promissory note, another real estate related document, a contract, or other document.

In at least one embodiment, digitizing the document can include performing an optical character recognition scan of the document. In at least one embodiment, extracting the data from the electronic version of the document can include conforming the data to a java script object notation format. In at least one embodiment, recording the executed version of the document can include electronically transmitting the executed version of the document to the governmental recordation system.

In at least one embodiment, recording the executed version of the document can include electronically transmitting at least a sub-set of the data extracted from the electronic version of the document to the governmental recordation system. In at least one embodiment, recording the executed version of the document can include receiving, from the governmental recordation system, recordation requirements; creating a recordation package in conformance with the recordation requirements, the recordation package including the executed version of the document and at least a sub-set of the data extracted from the electronic version of the document; transmitting the recordation package to the governmental recordation system; receiving, from the governmental recordation system, confirmation of recordation of the executed version of the document; and providing, to a user, notification of recordation of the executed version of the document.

In at least one embodiment, creating the hash of the document can include creating the hash from the electronic version of the document, the executed version of the document, the data extracted from the document, or any combination thereof. For example, the hash can be created from a sub-set of the data extracted from the electronic version of the document. In at least one embodiment, the hash includes a sub-set of the data extracted from the document. Any portion of the hash may be encoded, such that, for example, creating the hash of the document can include encoding at least a sub-set of the data extracted from the document. Thus, for example, the hash can include an encoded representation of at least a subset of the data extracted from the document.

In at least one embodiment, the executed version of the document can also be stored in the secure storage system. In at least one embodiment, the reference to the executed version of the document can include a link to the executed version of the document in the secure storage system. In at least one embodiment, the reference to the executed version of the document can include a link to the executed version of the document in the governmental recordation system.

In at least one embodiment, the data extracted from the electronic version of the document can be registered. In at least one embodiment, registering the data can include confirming the data conforms to a java script object notation format and a mortgage industry standard. In at least one embodiment, the data can be used to populate a record in a searchable database. In at least one embodiment, the record can be populated with the executed version of the document. In at least one embodiment, the reference to the executed version of the document can include a link to the executed version of the document in the record in the searchable database. In at least one embodiment, the searchable database can be distinct and independent from the secure storage system and the governmental recordation system, the secure storage system can be distinct and independent from the searchable database and the governmental recordation system, the governmental recordation system can be distinct and independent from the searchable database and the secure storage system, or any combination thereof.

In at least one embodiment, the secure storage system can include the data extracted from the document. In at least one embodiment, the non-fungible token can include the hash, which can be created from a sub-set of the data extracted from the electronic version of the document. In at least one embodiment, the non-fungible token can include a sub-set of the data extracted from the document.

In at least one embodiment, the hash in the non-fungible token on the blockchain can be updated when the data changes. In at least one embodiment, a new hash can be created when the data changes. The new hash can be added to the non-fungible token on the blockchain and/or be substituted for the previous hash in the non-fungible token on the blockchain. In at least one embodiment, the second, or new, hash can reference the first, or previous, hash.

In at least one embodiment, a system for secure document management can include a document execution sub-system; a secure storage sub-system; and a registration sub-system. In at least one embodiment, the document execution sub-system can be configured to receive a document, extract data from the document, facilitate electronic execution of the document, or any combination thereof. In at least one embodiment, the secure storage sub-system can be configured to securely store the data extracted from the document. In at least one embodiment, the registration sub-system can be configured to store the data extracted from the document, facilitate secured access to the data extracted from the document, record an electronically executed version of the document with an external governmental recordation entity, create a hash from the data extracted from the document, create a non-fungible token comprising the hash and a reference to the electronically executed version of the document, store the hash on a blockchain, or any combination thereof.

In at least one embodiment, the registration sub-system can be configured to allow full access to the data extracted from the document at a first security level, allow read-only access the data extracted from the document at a second access level, allow read-only access to a subset of the data extracted from the document at a third access level, or any combination thereof. In at least one embodiment, the registration sub-system can be configured to update the 1) hash in the non-fungible token on the blockchain, and/or 2) the data in the secure storage sub-system when the data extracted from the document changes. In at least one embodiment, the registration sub-system is further configured to render the document from the data in the secure storage sub-system. In at least one embodiment, the registration sub-system can be configured to validate a user, reject changes from an unvalidated user, accept a modifying document from a validated user, update the data in the secure storage sub-system upon acceptance of the modifying document, record the modifying document with the external governmental recordation entity upon acceptance of the modifying document, update the hash in the non-fungible token on the blockchain upon acceptance of the modifying document, or any combination thereof.

In at least one embodiment, the registration sub-system can be configured to securely store the electronically executed version of the document. In at least one embodiment, the reference to the electronically executed version of the document can include a link to the electronically executed version of the document in the registration sub-system and/or a link to the electronically executed version of the document at the external governmental recordation entity.

In at least one embodiment, the secure storage sub-system can be configured to securely store the electronically executed version of the document. In at least one embodiment, the reference to the electronically executed version of the document can include a link to the electronically executed version of the document in the secure storage sub-system.

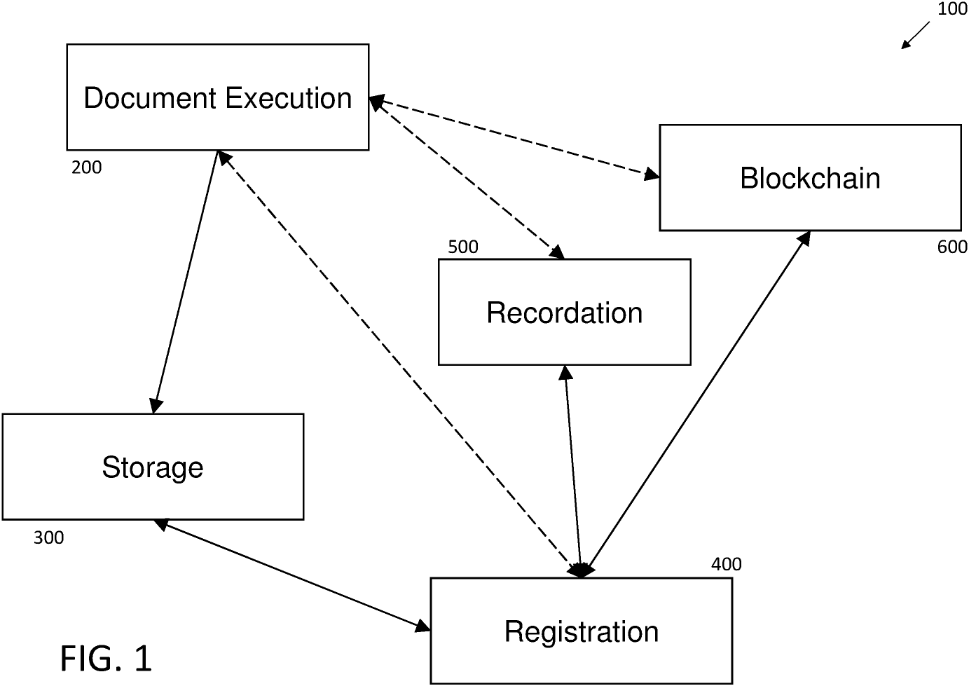

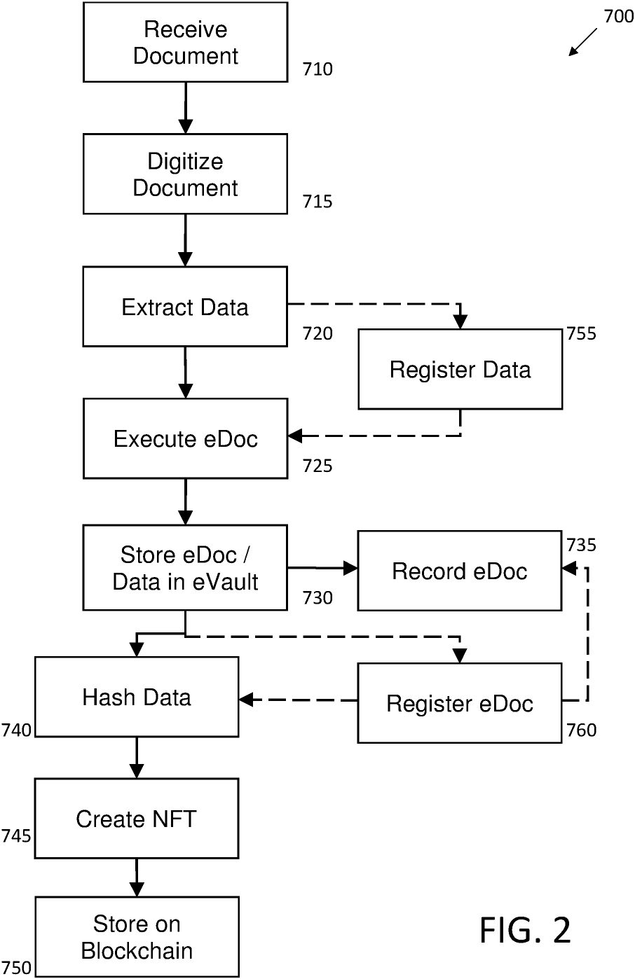

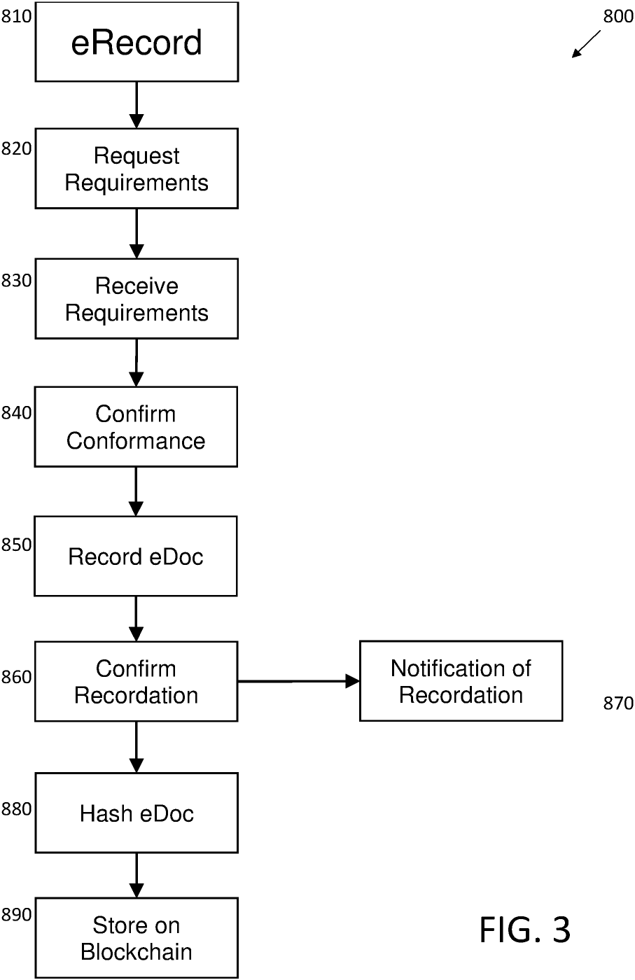

FIG. 1 is a block diagram of one of many embodiments of a system for secure document management according to the disclosure. FIG. 2 is a flow chart of one of many embodiments of a method for secure document management according to the disclosure. FIG. 3 is a flow chart of one of many embodiments of a method for secure document recordation according to the disclosure. FIGS. 1-3 are described in conjunction with one another.

In at least one embodiment, a system 100 for secure document management can include a document execution sub-system 200; a secure storage sub-system 300; and a registration sub-system 400. All or any of the systems and/or sub-systems described herein can include a processing system that can include a processor, memory to store executable instructions that allow the processing system to perform the operations described herein, and nonvolatile storage to store the executable instructions and/or the documents and data described herein. All or any of these systems and sub-systems can be connected via public networks, such as the Internet. All or any of these systems and sub-systems can be connected via private network and/or virtual private networks.

In at least one embodiment, the document execution sub-system 100 can be configured to receive a document, extract data from the document, facilitate electronic execution of the document, or any combination thereof. For example, in at least one embodiment, the document execution sub-system 200 can include features and capabilities described in U.S Pat. No. 10,713,714, which is incorporated herein. In at least one embodiment, the document execution sub-system 100 can receive a loan package, or other set of documents, including the document(s) to be processed as described herein. In at least one embodiment, the document execution sub-system 100 can digitize, such as by performing an optical character recognition (OCR) scan the document, and/or otherwise create an electronic version of the document, if the document is not received in a suitable electronic form.

In at least one embodiment, the document execution sub-system 100 can extract data from the document. The data can be extracted from the document as received, the electronic version of the document, an executed version of the document, or any combination thereof. The data can be formatted, such as in a Java Script Object Notation (JSON) format. The data can conform, or be conformed to, an industry standard, such as those promulgated by the Mortgage Industry Standards Maintenance Organization (MISMO).

The data can include data about the document and/or set of documents. For example, in at least one embodiment, the data can include such things as names and/or other identifying information, such as social security numbers drivers license numbers, etc., for each party involved with the document. In at least one embodiment, the data can include such things as names and addresses and/or other identifying information, such as tax identification numbers, for each location and/or real estate property involved with the document. In at least one embodiment, the data can include such things as any combination of names, addresses, and other identifying information for entities involved with the document, such as lenders, lending agents, closing agents, real estate agents, or other agents, or any combination thereof. In at least one embodiment, the data can include such things as loan information, such types, priority types, relevant dates, terms, other information about any loans associated with the document, or any combination thereof. In at least one embodiment, the data can include such things as deed information, such types, relevant dates, terms, other information about any deeds associated with the document, or any combination thereof. In at least one embodiment, the data can include other custom data, specific to the document or implementation of the present invention. The data elements described herein is not intended to be exhaustive, nor is it intended to imply that any implementation of the invention needs to include each and every data element.

In at least one embodiment, the secure storage sub-system 300 can be configured to securely store the data extracted from the document and/or the electronically executed version of the document. In at least one embodiment, the secure storage sub-system 300 can securely store the hash, a reference to the hash, a reference to the executed version of the document in a governmental registry, a reference to a non-fungible token on a blockchain, or any combination thereof. In at least one embodiment, the secure storage sub-system 300 can securely store the electronically executed version of the document and index the document using, for example, the data extracted from the document, such that it is searchable using the data extracted from the document or a subset thereof. In at least one embodiment, the secure storage sub-system 300 is only accessible by the document execution sub-system 100. In at least one embodiment, the secure storage sub-system 300 is only accessible by the registration sub-system 400. In at least one embodiment, the secure storage sub-system 300 is only accessible by the document execution sub-system 100 and/or the registration sub-system 400.

In at least one embodiment, the registration sub-system 400 can be configured to store the data extracted from the document, facilitate secured access to the data extracted from the document, record an electronically executed version of the document with an external governmental recordation entity 500, create a hash from the data extracted from the document, create a non-fungible token comprising the hash and a reference to the electronically executed version of the document, store the hash on a blockchain 600, or any combination thereof.

In at least one embodiment, the registration sub-system 400 can be configured to allow full access to the data extracted from the document at a first security level, allow read-only access the data extracted from the document at a second access level, allow read-only access to a subset of the data extracted from the document at a third access level, or any combination thereof. In at least one embodiment, the registration sub-system 400 can be configured to update the 1) hash in the non-fungible token on the blockchain 600, and/or 2) the data in the secure storage sub-system 300 when the data extracted from the document changes. For example, when the lender changes with respect to a deed or note, the registration sub-system 400 can update the data in the secure storage sub-system 300 and/or the recordation system 500. In at least one embodiment, when the lender changes with respect to a deed or note, the registration sub-system 400 can update the hash in the non-fungible token on the blockchain 600, and/or create a new hash for the non-fungible token on the blockchain 600. In at least one embodiment, the new hash can replace the previous hash in the non-fungible token on the blockchain 600. In at least one embodiment, the new hash can refer to the previous hash in the non-fungible token on the blockchain 600.

In at least one embodiment, the registration sub-system 400 can be configured to validate a user, reject changes from an unvalidated user, accept a modifying document from a validated user, update the data in the secure storage sub-system 300 upon acceptance of the modifying document, record the modifying document with the external governmental recordation entity 500 upon acceptance of the modifying document, update the hash in the non-fungible token on the blockchain 600 upon acceptance of the modifying document, or any combination thereof.

In at least one embodiment, the registration sub-system 400 can be configured to securely store the electronically executed version of the document. In at least one embodiment, the reference to the electronically executed version of the document can include a link to the electronically executed version of the document in the registration sub-system 400 and/or a link to the electronically executed version of the document at the external governmental recordation entity 500. In at least one embodiment, the reference to the electronically executed version of the document can include a link to the electronically executed version of the document in the secure storage sub-system 300.

In at least one embodiment, the registration sub-system 400 is further configured to render the document from the secure storage sub-system 300. In at least one embodiment, the registration sub-system 400 is further configured to render the document from the data in the secure storage sub-system 300.

In at least one embodiment, the recordation system 500 can include a governmental recordation entity, such as a county real estate registry office that records real estate records. In at least one embodiment, the recordation system 500 can include a third-party vendor that interfaces between the present invention and the governmental recordation entity. In at least one embodiment, the recordation system 500 can include an official registration system for documents of the type used with any specific implementation of the present inventions and/or a third-party vendor that interfaces between the present invention and any such registration system.

The blockchain system 600 may include the IBM blockchain, the Tron blockchain, the Steller blockchain, the Tezos blockchain, the Corda blockchain, the Ethereum blockchain, the Multichain blockchain, the EOS blockchain, the Hyperledger Fabric blockchain, the Open-Chain blockchain, the Quorum blockchain, the Hyperledger Sawtooth blockchain, the Solana blockchain, another blockchain, or any combination thereof. For example, blockchain can be used in connection with one region and/or type of document, while another blockchain can be used in connection with another region and/or type of document.

In at least one embodiment, the document execution sub-system 200 and the registration sub-system 400 can communication directly with the secure storage sub-system 300, with the registration sub-system 400 also communicating directly with the recordation system 500 and/or the blockchain system 600. In at least one embodiment, the document execution sub-system 200 can also communicate directly with the registration sub-system 400, the recordation system 500, the blockchain system 600, or any combination thereof.

In at least one embodiment, the document execution sub-system 200 can extract the data from the document and/or store both the data and the executed version of the document on the secure storage sub-system 300. The registration sub-system 400 can retrieve the data and the executed version of the document from the secure storage sub-system 300, record the executed version of the document with the recordation system 500, create the hash, create the non-fungible token containing the hash, store the non-fungible token on the blockchain system 600, or any combination thereof.

In at least one embodiment, the document execution sub-system 200 can send the data to the registration sub-system 400 and/or record the executed version of the document with the recordation system 500. In at least one embodiment, the document execution sub-system 200 can create the hash, create the non-fungible token containing the hash, store the non-fungible token on the blockchain system 600, or any combination thereof.

In at least one embodiment, a method 700 for secure document management can include receiving the document, as shown in step 710. In at least one embodiment, the document can be a real estate deed, a promissory note, another real estate related document, a contract, or other document.

In at least one embodiment, the method 700 can include creating an electronic version of the document, such as by digitizing the document, if it is not received in an electronic format, as shown in step 715. In at least one embodiment, digitizing the document can include performing an optical character recognition scan of the document.

In at least one embodiment, the method 700 can include extracting data from the document, as shown in step 720. In at least one embodiment, the method 700 can include extracting data from the electronic version of the document. In at least one embodiment, the method 700 can include extracting data from the document, as received. In at least one embodiment, the method 700 can include extracting data from the executed version of the document. In at least one embodiment, extracting the data from the document can include conforming the data to a JSON format. In at least one embodiment, extracting the data from the document can include conforming the data to an industry standard, such as those promulgated by MISMO.

In at least one embodiment, the method 700 can include executing the document, as shown in step 725. In at least one embodiment, the method 700 can include receiving an executed version of the document. For example, the system 100 of the present invention can receive the document in unexecuted form and facilitate execution of the document, such as by using the document execution sub-system 200. In at least one embodiment, the system 100 of the present invention can receive the document in unexecuted form and communicate the document to another system or sub-system to facilitate execution of the document. In at least one embodiment, the system 100 of the present invention can receive the document in executed form.

In at least one embodiment, as shown in step 730, the method 700 can include storing the data in a secure storage system, such as the secure storage system 300. In at least one embodiment, as shown in step 730, the method 700 can include storing the document in a secure storage system, such as the secure storage system 300. The document can be stored in a secure storage system as the document is received, in electronic form, as executed, or any combination thereof.

In at least one embodiment, the method 700 can include recording the executed version of the document, as shown in step 735. In at least one embodiment, the document can be recorded with a governmental recordation system, such as a county clerk of court, register of deed, real estate registry, other governmental registry, or any combination thereof. In at least one embodiment, the document can be recorded with a privately operated recordation system. In at least one embodiment, the document can be recorded with a governmental recordation system using a privately operated vendor. In at least one embodiment, recording the document can include electronically transmitting the executed version of the document to the governmental recordation system. In at least one embodiment, recording the document can include electronically transmitting at least a sub-set of the data extracted from the document to the governmental recordation system.

In at least one embodiment, the method 700 can include creating a hash of the document, as shown in step 740. In at least one embodiment, creating the hash of the document can include creating the hash from the electronic version of the document, the executed version of the document, the data extracted from the document, or any combination thereof. For example, the hash can be created from a sub-set of the data extracted from the electronic version of the document. In at least one embodiment, the hash includes a sub-set of the data extracted from the document. Any portion of the hash may be encoded, such that, for example, creating the hash of the document can include encoding at least a sub-set of the data extracted from the document. Thus, for example, the hash can include an encoded representation of at least a subset of the data extracted from the document.

In at least one embodiment, the method 700 can include creating a non-fungible token for the document, as shown in step 745, the non-fungible token (NFT). In at least one embodiment, the NFT can include the hash and/or a reference to the executed version of the document. In at least one embodiment, the reference can include a link to the document as received, the electronic version of the document, an executed version of the document, or any combination thereof.

In at least one embodiment, the NFT can include a reference, such as a link, to the document in the recordation sub-system 500. In at least one embodiment, the NFT can include a reference, such as a link, to the document in the storage sub-system 300. In at least one embodiment, the NFT can include a reference, such as a link, to the document in the registration sub-system 400. In at least one embodiment, the method 700 can include storing the NFT on a blockchain 600, as shown in step 750.

In at least one embodiment, the data extracted from the document can be registered, as shown in step 755. In at least one embodiment, registering the data can include confirming the data conforms to a JSON format and/or an industry standard, such as those promulgated my MISMO. In at least one embodiment, the data can be used to populate a record in a searchable database.

In at least one embodiment, the document itself can be registered, as shown in step 760. In at least one embodiment, the record can also, or alternatively, be populated with the document, such as the document as received, the electronic version of the document, the executed version of the document, or any combination thereof. In at least one embodiment, the reference to the document can include a link to the executed version of the document in the record in the searchable database.

In at least one embodiment, the searchable database can be provided by the registration sub-system 400. In at least one embodiment, the searchable database can be distinct and independent from the secure storage system 300 and the recordation system 500. In at least one embodiment, the secure storage system 300 can be distinct and independent from the searchable database and the recordation system 500. In at least one embodiment, the recordation system 500 can be distinct and independent from the searchable database and the secure storage system 300. Any of the secure storage system 300, the searchable database, the registration sub-system 400, the recordation system 500 can be integrated with one another, completely independent of one another, or any combination thereof.

In at least one embodiment, the method 700 can include a process 800 for recording the executed version of the document. One or more steps of process 800 can be performed in place of similar steps of the method 700 discussed above, concurrently with steps of the method 700, sequentially with steps of the method 700, or any combination thereof. In at least one embodiment, the process 800 can begin by receiving, transmitting, or detecting an electronic recordation signal or message, as shown in step 810.

In at least one embodiment, the process 800 can include requesting recordation requirements of the recordation system 500 recordation requirements, as shown in step 820. Such a request can be sent to the recordation system 500, a recordation vendor, a database storing such data, or any combination thereof.

In at least one embodiment, the process 800 can include receiving, from the recordation requirements, as shown in step 830. The recordation requirements can be received from to the recordation system 500, a recordation vendor, a database storing such data, or any combination thereof.

In at least one embodiment, the method 700 and/or process 800 can include creating a recordation package in conformance with the recordation requirements. Such a recordation package can include the executed version of the document and/or at least a sub-set of the data extracted from the document. In at least one embodiment, the process 800 can include confirming that the recordation package, the document, the data, or any combination thereof conforms to the recordation requirements, as shown in step 840.

In at least one embodiment, the process 800 can include recording the recordation package, the document, the data, or any combination thereof with the recordation system 500, as shown in step 850. In at least one embodiment, recording can include transmitting, electronically or otherwise, the recordation package, the document, the data, or any combination thereof to the recordation system 500.

In at least one embodiment, the process 800 can include confirming recordation, as shown in step 860. In at least one embodiment, confirming recordation can include receiving, from the recordation system 500 or the vendor, confirmation of recordation of the executed version of the document. In at least one embodiment, confirming recordation can include receiving, from the recordation system 500 or the vendor, confirmation of recordation of the recordation package, the document, the data, or any combination thereof.

In at least one embodiment, the process 800 can include providing, to a user, notification of recordation of the document, as shown in step 870. In at least one embodiment, the process 800 can include creating a hash of the document, the data, notification of recordation, or any combination thereof, as shown in step 880. In at least one embodiment, the process 800 can include storing the hash on the blockchain, such as within a NFT on the blockchain, as shown in step 890.

In at least one embodiment, the secure storage system 300 can include the data extracted from the document. In at least one embodiment, the NFT can include the hash, which can be created from a sub-set of the data extracted from the electronic version of the document. In at least one embodiment, the NFT can include a sub-set of the data extracted from the document.

In at least one embodiment, the hash in the NFT on the blockchain 600 can be updated when the data changes. In at least one embodiment, a new hash can be created when the data changes. The new hash can be added to the NFT on the blockchain 600 and/or be substituted for the previous hash in the NFT on the blockchain 600. In at least one embodiment, the second, or new, hash can reference the first, or previous, hash.

In at least one embodiment, a new NFT can be created when the data changes. The new NFT can be added to the blockchain 600 and/or be substituted for the previous NFT already on the blockchain 600. In at least one embodiment, the second, or new, NFT can reference the first, or previous, NFT.

Other and further embodiments utilizing one or more aspects of the disclosure can be devised without departing from the spirit of Applicants’ disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice-versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicants, but rather, in conformity with the patent laws, Applicants intend to fully protect all such modifications and improvements that come within the scope or range of equivalents of the following claims.

What is claimed is:

1. A method for secure document management, the method comprising:
receiving the document;
digitizing the document, thereby creating an electronic version of the document;
extracting data from the electronic version of the document;
receiving an executed version of the document;
storing the data in a secure storage system;
recording the executed version of the document in a governmental recordation system;
creating a hash of the document;
creating a non-fungible token for the document, the non-fungible token including the hash and a reference to the executed version of the document; and
storing the non-fungible token on a blockchain.

2. The method of claim 1, further including storing the executed version of the document in the secure storage system and wherein the reference to the executed version of the document comprises a link to the executed version of the document in the secure storage system.

3. The method of claim 1, wherein recording the executed version of the document comprises:
receiving, from the governmental recordation system, recordation requirements;
creating a recordation package in conformance with the recordation requirements, the recordation package including the executed version of the document and at least a sub-set of the data extracted from the electronic version of the document;
transmitting the recordation package to the governmental recordation system;
receiving, from the governmental recordation system, confirmation of recordation of the executed version of the document; and
providing, to a user, notification of recordation of the executed version of the document.

4. The method of claim 1, wherein creating the hash of the document comprises encoding at least a sub-set of the data extracted from the electronic version of the document.

5. The method of claim 1, further including:
confirming the data conforms to a java script object notation format and a mortgage industry standard; and
populating a record in a searchable database with the data and the executed version of the document.

6. The method of claim 5, wherein the reference to the executed version of the document comprises a link to the executed version of the document in the record in the searchable database.

7. The method of claim 5, wherein the searchable database is distinct and independent from the secure storage system and the governmental recordation system, wherein the secure storage system is distinct and independent from the searchable database and the governmental recordation system, and wherein the governmental recordation system is distinct and independent from the searchable database and the secure storage system.

8. The method of claim 1, further including updating the hash in the non-fungible token on the blockchain when the data is changed.

9. The method of claim 1, wherein the hash is a first hash, further including creating a second hash of the document when the data is changed, and wherein the second hash references the first hash.

10. A system for secure document management, the system comprising:
a document execution sub-system configured to receive a document, extract data from the document, and facilitate electronic execution of the document;
a secure storage sub-system configured to securely store the data extracted from the document;
a registration sub-system configured to store the data extracted from the document, facilitate secured access to the data extracted from the document, record an electronically executed version of the document with an external governmental recordation entity, create a hash from the data extracted from the document, create a non-fungible token comprising the hash and a reference to the electronically executed version of the document, and store the hash on a blockchain.

11. The system of claim 10, wherein the registration sub-system is further configured to allow full access to the data extracted from the document at a first security level, allow read-only access the data extracted from the document at a second access level, and allow read-only access to a subset of the data extracted from the document at a third access level.

12. The system of claim 10, wherein the registration sub-system is further configured to update the hash in the non-fungible token on the blockchain when the data extracted from the document changes.

13. The system of claim 10, wherein the registration sub-system is further configured to update the data in the secure storage sub-system when the data extracted from the document changes.

14. The system of claim 10, wherein the registration sub-system is further configured to render the document from the data in the secure storage sub-system.

15. The system of claim 10, wherein the reference to the electronically executed version of the document comprises a link to the electronically executed version of the document at the external governmental recordation entity.

16. The system of claim 10, wherein the secure storage sub-system is further configured to securely store the electronically executed version of the document and wherein the reference to the electronically executed version of the document comprises a link to the electronically executed version of the document in the secure storage sub-system.

17. The system of claim 10, wherein the registration sub-system is further configured to securely store the electronically executed version of the document and wherein the reference to the electronically executed version of the document comprises a link to the electronically executed version of the document in the registration sub-system.

18. The system of claim 10, wherein the hash comprises a subset of the data extracted from the document.

19. The system of claim 10, wherein the hash comprises an encoded representation of at least a subset of the data extracted from the document.

20. The system of claim 10, wherein the registration sub-system is further configured to validate a user, reject changes from an unvalidated user, accept a modifying document from a validated user, update the data in the secure storage sub-system upon acceptance of the modifying document, record the modifying document with the external governmental recordation entity upon acceptance of the modifying document, and update the hash in the non-fungible token on the blockchain upon acceptance of the modifying document.
